(19) United States
(12) Patent Application Publication
(10) Pub. No.: US 2021/0258276 A1
(43) Pub. Date: Aug. 19, 2021

(54) SYSTEMS AND METHODS FOR DIGITAL COMMUNICATIONS ROUTING AND MANAGEMENT

(71) Applicant: Facebook, Inc., Menlo Park, CA (US)

(72) Inventor: Li Hua, Bellevue, WA (US)

(21) Appl. No.: 15/935,949

(22) Filed: Mar. 26, 2018

(51) Int. Cl. H04L 12/58

(52) U.S. Cl. CPC H04L 51/32; H04L 51/08; H04L 51/046

(57) ABSTRACT

Systems, methods, and non-transitory computer-readable media can receive a call request generated based on a virtual call token associated with a first user, wherein the call request is initiated by a second user. It is determined that one or more call conditions associated with the virtual call token are satisfied. The first user is notified of the call request from the second user based on the determination that the one or more call conditions are satisfied.

### FIELD OF THE INVENTION

The present technology relates to the field of digital communications. More particularly, the present technology relates to routing and management of digital communications.

### BACKGROUND

Today, people often utilize computing devices for a wide variety of purposes. Users can use their computing devices, for example, to communicate with other users. Such communications are increasingly popular over a social networking system. Digital communications, such as those on a social networking system, may involve various types of communication. Some types of digital communication allow a user to engage in focused exchanges. For example, the user may target other users through a messaging system or an email system supported by a social networking system. As another example, the user can participate in audio communications or video communications with other users.

### SUMMARY

Various embodiments of the presently disclosed technology can include systems, methods, and non-transitory computer readable media configured to receive a call request generated based on a virtual call token associated with a first user, wherein the call request is initiated by a second user. It is determined that one or more call conditions associated with the virtual call token are satisfied. The first user is notified of the call request from the second user based on the determination that the one or more call conditions are satisfied.

In an embodiment, the virtual call token is at least one of a hyperlink, a QR code, or an alpha-numeric sequence.

In an embodiment, the virtual call token is a hyperlink, and the call request is generated based on the second user selecting the hyperlink.

In an embodiment, the hyperlink is a deep link, and further wherein selection of the hyperlink causes a computing device to automatically open a messaging application to generate a call request.

In an embodiment, the call request comprises user identifying information associated with the second user and a unique identifier associated with the virtual call token.

In an embodiment, the one or more call conditions comprise a time-based condition.

In an embodiment, the time-base condition specifies at least one of a first time range during which the virtual call token is operative, or a second time range during which the virtual call token is inoperative.

In an embodiment, the one or more call conditions comprise a set of users that are permitted to use the virtual call token to initiate call requests to the first user.

In an embodiment, the one or more call conditions comprise a set of users that are not permitted to use the virtual call token to initiate call requests to the first user.

In an embodiment, the first user is associated with a plurality of virtual call tokens, a first virtual call token of the plurality of virtual call tokens is associated with a first set of call conditions, and a second virtual call token of the plurality of virtual call tokens is associated with a second set of call conditions that is different from the first set of call conditions.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including a virtual call token module, according to an embodiment of the presently disclosed technology.

FIG. 2 illustrates an example call module, according to an embodiment of the presently disclosed technology.

FIGS. 3A and 3B illustrate an example user interfaces associated with generation and management of virtual call tokens, according to an embodiment of the presently disclosed technology.

FIG. 4 illustrates an example flow diagram associated with implementing digital communications based on virtual call tokens, according to an embodiment of the presently disclosed technology.

FIG. 5 illustrates an example method associated with implementing digital communications based on virtual call tokens, according to an embodiment of the presently disclosed technology.

FIG. 6 illustrates a network diagram of an example system including an example social networking system that can be utilized in various scenarios, according to an embodiment of the presently disclosed technology.

FIG. 7 illustrates an example of a computer system or computing device that can be utilized in various scenarios, according to an embodiment of the presently disclosed technology.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Routing and Management of Digital Communications

As mentioned, people often utilize computing devices for a wide variety of purposes. Users can use their computing devices, for example, to communicate with other users. Such communications are increasingly popular over a social networking system. Digital communications, such as those on a social networking system, may involve various types of communication. Some types of digital communication allow a user to engage in focused exchanges. For example, the user may target other users through a messaging system or an email system supported by a social networking system. As another example, the user can participate in audio communications or video communications with other users.

Under conventional approaches, users can place calls to other users using telephone numbers. Telephone numbers are typically owned, distributed, and/or assigned by telecommunications carriers. Once a user gives his or her telephone number to another person, the user has given that person implicit permission to contact the user using the telephone number. Often, it can be cumbersome, difficult, or expensive for a user to change his or her telephone number. This can be particularly problematic in instances where the user's telephone number has been improperly obtained by a third party, or where the user's telephone number is being misused by a person who may have legitimately obtained the telephone number. For example, if a person improperly obtains access to a user's telephone number, the user may have to take the steps of obtaining a new number, and informing all of his or her contacts of the new number.

Certain conventional approaches, specifically arising in the realm of computer technology, allow users to obtain alternative telephone numbers distributed by, for example, by an internet-based service provider. However, such approaches suffer from many of the shortcomings associated with traditional telephone numbers. For example, once a telephone number has been compromised (e.g., by a person who is misusing the number, or improperly obtained the number), the user must go through the troublesome process of informing other legitimate users who are using the number not to use the number anymore, and to use a new alternative number.

Other conventional approaches to digital communications, specifically arising in the realm of computer technology, include approaches in which users are provided with a call-in link or dial-in link for a meeting. The dial-in link is associated with a virtual space, such that users dialing in using the same dial-in link at the same time are placed into a meeting with one another. Such approaches require meeting participants to come to a prior understanding of when a meeting will take place, and for all meeting participants to actively join the meeting at the same time. While useful for a particular, limited purpose, such conventional approaches do not allow users to directly contact one another.

An improved approach rooted in computer technology overcomes the foregoing and other disadvantages associated with conventional approaches specifically arising in the realm of computer technology. In general, a service provider can generate one or more virtual call tokens for a user. For example, the service provider may be a social networking system. A virtual call token can be any unique code or token that can be associated with a user and used to route calls to the user. For example, virtual call tokens can include hyperlinks, QR codes, alpha-numeric codes, and the like. Each virtual call token can be associated with a user. A virtual call token can also be associated with control information. The control information can specify one or more controls (or restrictions) imposed on the virtual call token. For example, the control information can specify a timeframe during which the virtual call token is operative, one or more users that have permission to contact the associated user using the virtual call token, one or more users that do not have permission to use the virtual call token, and the like. The service provider can maintain virtual call token information which identifies, for each virtual call token, an associated user and any relevant control information.

A first user can provide a second user with access to a virtual call token, which the second user can use to contact the first user. For example, if the virtual call token is a unique hyperlink, the first user can provide the second user with the unique hyperlink. In certain instances, the first user can provide the hyperlink to only the second user, such that the hyperlink serves as a unique virtual call token for use only by the second user, or alternatively, the first user can provide multiple users with the same hyperlink. The second user can utilize the virtual call token (e.g., by clicking on the hyperlink, or typing the hyperlink into a browser or messaging application) in order to initiate a call with the first user. In various embodiments, the call can be an audio call and/or a video call. When the second user utilizes the unique hyperlink, the service provider can determine that the unique hyperlink is associated with the first user. The service provider can also perform a check to determine that one or more conditions are satisfied for connecting the second user to the first user. The one or more conditions may be specified, for example, by the control information associated with the virtual call token. If the one or more conditions are satisfied, the service provider can notify the first user that the second user is attempting to contact the first user. If the first user responds to the notification, a call can be connected between the first user and the second user. In an embodiment, the present disclosed technologies do not utilize a public switched telephone network (PTSN). More details relating to the disclosed technology are provided below.

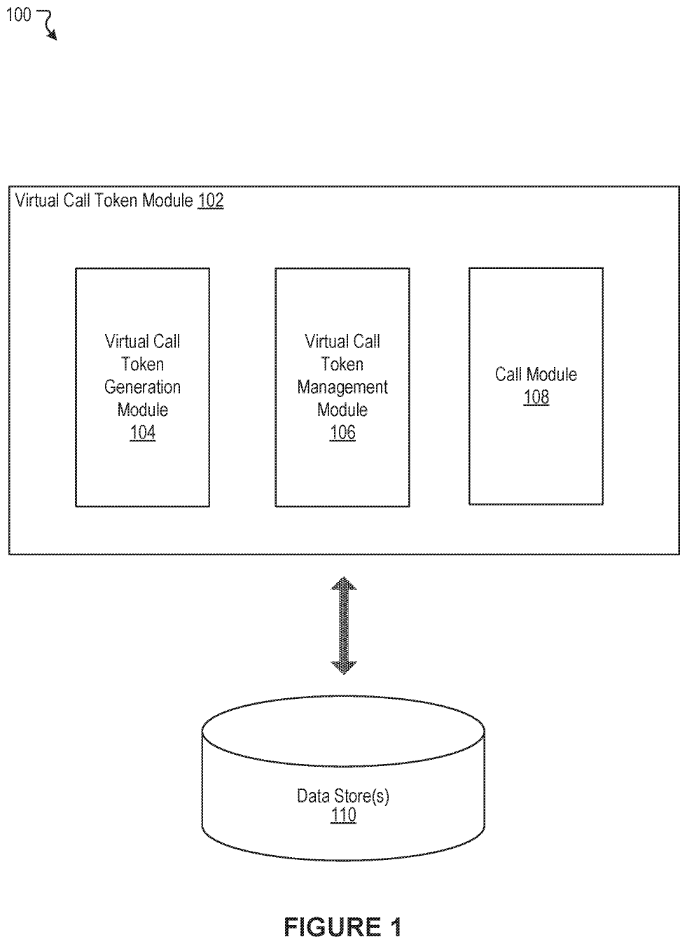

FIG. 1 illustrates an example system 100 including a virtual call token module 102, according to an embodiment of the presently disclosed technology. As shown in the example of FIG. 1, the virtual call token module 102 can include a virtual call token generation module 104, a virtual call token management module 106, and a call module 108. In some instances, the example system 100 can include at least one data store 110. The components (e.g., modules, elements, etc.) shown in this figure and all figures herein are exemplary only, and other implementations may include additional, fewer, integrated, or different components. Some components may not be shown so as not to obscure relevant details. In various embodiments, one or more of the functionalities described in connection with the virtual call token module 102 can be implemented in any suitable combinations.

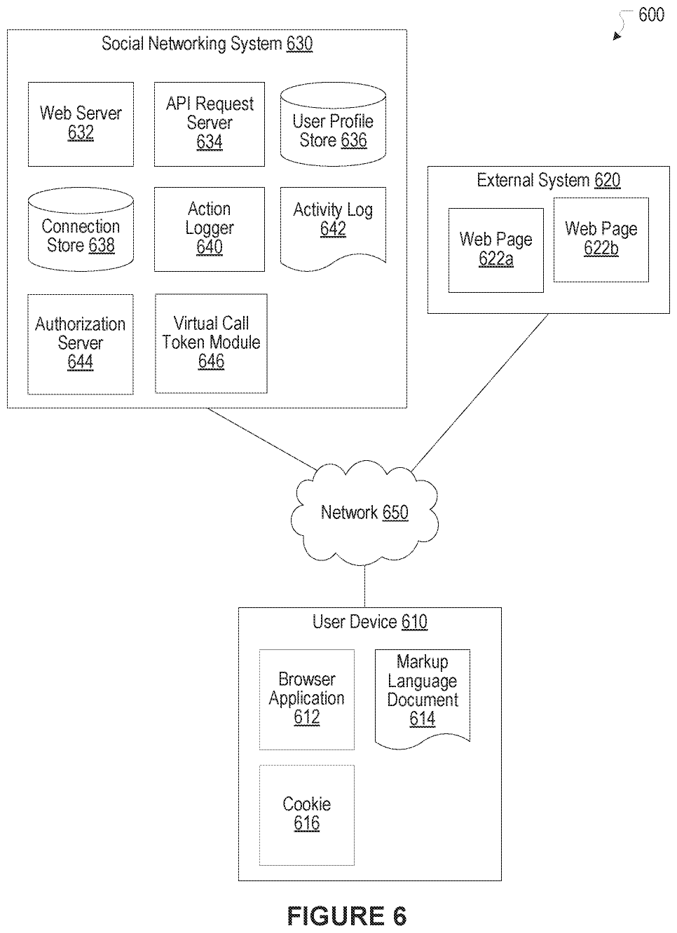

In some embodiments, the virtual call token module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the virtual call token module 102 can be, in part or in whole, implemented as software running on one or more computing devices or systems, such as on a server system or a client computing device. In some instances, the virtual call token module 102 can be, in part or in whole, implemented within or configured to operate in conjunction with or be integrated with a social networking system (or service), such as a social networking system 630 of FIG. 6. Likewise, in some instances, the virtual call token module 102 can be, in part or in whole, implemented within or configured to operate in conjunction with or be integrated with a client computing device, such as the user device 610 of FIG. 6. For example, the virtual call token module 102 can be implemented as or within a dedicated application (e.g., app), a program, or an applet running on a user computing device or client computing system. The application incorporating or implementing instructions for performing functionality of the virtual call token module 102 can be created by a developer. The application can be provided to or maintained in a repository. In some cases, the application can be uploaded or otherwise transmitted over a network (e.g., Internet) to the repository. For example, a computing system (e.g., server) associated with or under control of the developer of the application can provide or transmit the application to the repository. The repository can include, for example, an “app” store in which the application can be maintained for access or download by a user. In response to a command by the user to download the application, the application can be provided or otherwise transmitted over a network from the repository to a computing device associated with the user. For example, a computing system (e.g., server) associated with or under control of an administrator of the repository can cause or permit the application to be transmitted to the computing device of the user so that the user can install and run the application. The developer of the application and the administrator of the repository can be different entities in some cases, but can be the same entity in other cases. It should be understood that many variations are possible.

The virtual call token module 102 can be configured to communicate and/or operate with the at least one data store 110, as shown in the example system 100. The data store 110 can be configured to store and maintain various types of data. In some implementations, the data store 110 can store information associated with the social networking system (e.g., the social networking system 630 of FIG. 6). The information associated with the social networking system can include data about users, user identifiers, social connections, social interactions, profile information, demographic information, locations, geo-fenced areas, maps, places, events, pages, groups, posts, communications, content, feeds, account settings, privacy settings, a social graph, and various other types of data. In some implementations, the data store 110 can store information that is utilized by the virtual call token module 102. For example, the data store 110 can store virtual call token information for a set of virtual call tokens including, for each virtual call token, an associated user and a set of control information, and the like.

The virtual call token generation module 104 can be configured to generate a virtual call token for a user. In an embodiment, the virtual call token may be generated for a user and provided by a service provider, such as a social networking system. The virtual call token can be associated with the user, such that if another user utilizes the virtual call token to initiate a call, the call is routed to the user. In an embodiment, routing of calls can be performed by the service provider, and calls may take place on a platform provided by the service provider and/or calls may be conducted using an application provided by the service provider. For example, if the service provider is a social networking system, calls may take place on a communications platform provided by the service provider and calls may be conducted using a messaging application provided by the service provider. In an embodiment, a user can submit a request to generate a new virtual call token, for example, using a user interface on a software application. The request can include user information associated with the user. The user information can include identifying information identifying the user. For example, the user information can include social networking system information identifying a profile of the user and/or a user ID of the user on the social networking system.

A virtual call token can be or include any unique code that can be associated with the user and used to route calls to the user. For example, the virtual call token can be a hyperlink, a QR code, an alpha-numeric sequence, and the like. When a virtual call token is generated for a user, the virtual call token generation module 104 can store information (e.g., in a database) associating the virtual call token with the user. The virtual call token generation module 104 can transmit the virtual call token to the user. The user can then share the virtual call token with any other users so that the other users can use the virtual call token to call the user. The user can share the virtual call token in any appropriate manner. For example, the user can copy and paste the virtual call token into a message (e.g., copying a hyperlink, QR code, or alpha-numeric sequence into an email or other electronic message), or the user can print a physical copy of the virtual call token and hand the physical copies out to other users (e.g., a piece of paper that includes the hyperlink, QR code, or alpha-numeric sequence). In an embodiment, there is no practical limit to the number of virtual call tokens a user can generate, such that a user can be associated with an unlimited number of virtual call tokens. The user can distribute different virtual call tokens to different users. Even if different users have different virtual call tokens, as long as a virtual call token is associated with the user, calls initiated using the virtual call token will be routed to the user.

In addition to being associated with a particular user, each virtual call token can also be associated with control information detailing one or more controls or restrictions on the virtual call token. When a virtual call token is generated, the virtual call token generation module 104 can receive and store one or more controls specified by a user generating the virtual call token. Controls on a virtual call token can include any controls that a user may wish to implement. In one example, controls can include time-based controls, such as a control identifying a time range during which the virtual call token is active, such that at all other times, the virtual call token is inoperative. In another example, controls can include user-based controls, such as a control identifying one or more users that are authorized to use the virtual call token to contact the user associated with the virtual call token, or a control identifying one or more users that are not authorized to use the virtual call token to contact the user associated with the virtual call token. In another example, controls can include information sharing controls, such as a control specifying that users who initiate a call using the virtual call token have access to certain types of information, or do not have access to certain types of information. For example, a control can indicate that users that initiate a call to a particular user using a particular virtual call token can be provided with access to a social networking system profile associated with the particular user, whereas users that initiate a call to the particular user using a different virtual call token may not to be provided with access to the particular user's social networking system profile. In some instances, control information for a virtual call token may indicate that there are no restrictions or controls on the virtual call token. Each virtual call token can be associated with a different set of control information, and each virtual call token can be managed individually.

The virtual call token management module 106 can be configured to allow a user to manage virtual call tokens associated with the user. For example, the virtual call token management module 106 can be implemented using a user interface that the user can access to manage his or her virtual call tokens. Using the user interface, the user can add, remove, and/or otherwise modify controls on each virtual call token. For example, the user can change an expiration date or an active time range for a virtual call token, add or remove users that are permitted to use particular virtual call tokens, add or remove users that are not permitted to use particular virtual call tokens, and the like. In an embodiment, the user can also add or remove virtual call tokens.

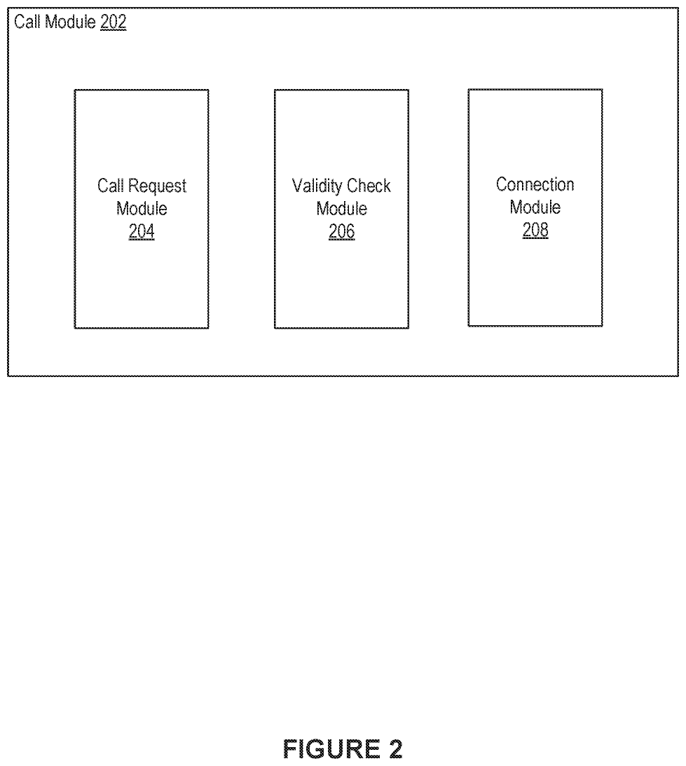

The call module 108 can be configured to provide functionality for implementing calls between users based on virtual call tokens. More details regarding the call module 108 will be provided below with reference to FIG. 2.

FIG. 2 illustrates an example call module 202 according to an embodiment of the presently disclosed technology. In some embodiments, the call module 108 of FIG. 1 can be implemented as the call module 202. As shown in the example of FIG. 2, the call module 202 can include a call request module 204, a validity check module 206, and a connection module 208.

The call request module 204 can be configured to receive, from a requesting user, a request to initiate a call. The call request may be associated with a virtual call token. A second user (or the requesting user), having received a virtual call token from a first user, can interact with the virtual call token and/or utilize the virtual call token to generate a call request to call the first user. For example, if the virtual call token is a hyperlink, the second user may have clicked on the hyperlink. Or, if the virtual call token is a QR code, the second user may have scanned in the QR code on an appropriate software application. Or, if the virtual call token is an alpha-numeric code, the second user may have entered the alpha-numeric code on an appropriate software application. In an embodiment, the virtual call token can be configured to automatically open an appropriate software application for generating and/or transmitting a call request. For example, if the virtual call token is a hyperlink, the hyperlink may be a deep link which contains a universal resource identifier (URI) which causes a computing device operating system to open a particular software application, and causes the particular software application to automatically generate a call request to initiate a call to a user associated with the virtual call token. Consider an example hyperlink https://m.messengerapplication/call/CtVQ5z10kR. The portion “m.messengerapplication” may indicate to an operating system that a software application “Messenger Application” should be opened. The portion “call” may indicate that a “call” feature in the Messenger Application should be utilized to generate a call request. The portion “CtVQ5z10kR” may be a unique identifier associated with the virtual call token that can be transmitted with the call request. The call request module 204 can receive the unique identifier with the call request to determine that the call request is associated with the virtual call token, and can identify a user and control information associated with the virtual call token.

The validity check module 206 can be configured to perform a validity check in response to receiving a call request from a requesting user. As mentioned above, a call request can be associated with a virtual call token. The virtual call token can be associated with a user and control information. The control information may specify one or more controls, and the one or more controls may specify one or more call conditions. The validity check module 206 can determine whether or not the one or more call conditions are satisfied. For example, if the control information specifies an allowed time range during which the virtual call token is active, the validity check module 206 can determine whether a current time at which the call request was made is within the allowed time range. In another example, if the control information identifies one or more users that are not permitted to use the virtual call token, the validity check module 206 can determine whether the requesting user is not included in the one or more users. If applicable call conditions are satisfied, the user associated with the virtual call token (i.e., the user being called, or the receiving user) can be notified that the requesting user is attempting to initiate a call. If applicable call conditions are not satisfied, the requesting user can be informed that the call could not be completed. For example, the requesting user may receive a message on a user interface indicating that he or she is not authorized to utilize the virtual call token, or that the virtual call token has expired or currently cannot be used to complete a call.

The connection module 208 can be configured to notify a receiving user of an incoming call request from a requesting user. As discussed above, in an embodiment, a receiving user is notified of an incoming call only if one or more call conditions are satisfied. In one embodiment, the notification of an incoming call can include requesting user identifying information such that the receiving user can see who is calling. For example, requesting user identifying information can include a name of the requesting user, a social networking system profile picture of the requesting user, and/or a link to the requesting user's social networking system profile. In an embodiment, the notification of the incoming call can be provided via a messaging application, such as a messaging application provided by a social networking system. A user may be associated with multiple instances of the messaging application. For example, the user may be logged into the messaging application on multiple computing devices. In certain embodiments, the notification may be provided on all instances of the messaging application associated with the receiving user (e.g., on all computing devices on which the receiving user is signed into the messaging application).

If the receiving user chooses to accept the call, the connection module 208 can connect a call between the receiving user and the requesting user. In an embodiment, the present disclosed technologies do not utilize a public switched telephone network (PTSN) to carry out calls between users. If the receiving user chooses not to accept the call, or does not respond to the call, the connection module 208 can send a notification to the requesting user indicating that the call could not be completed.

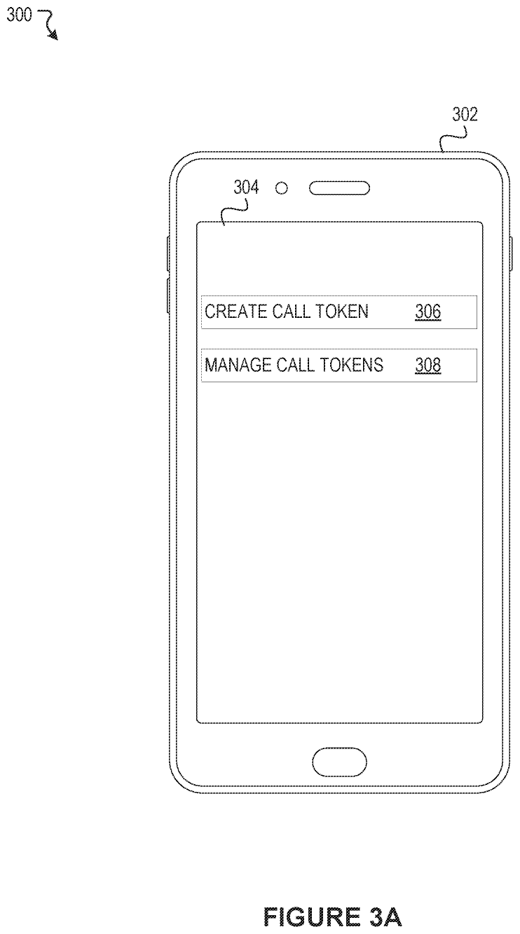

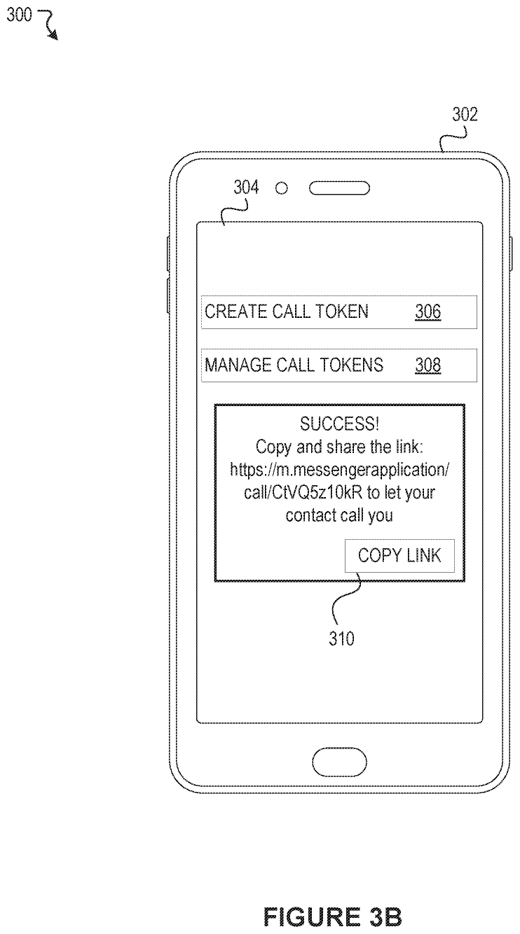

FIGS. 3A-3B illustrates an example scenario 300, including various example user interfaces associated with virtual call token generation and management, according to an embodiment of the presently disclosed technology. The example scenario 300 includes an example user interface 304 on a computing device 302. In FIG. 3A, the user interface 304 includes an option 306 to create a virtual call token. The user interface 304 also includes an option 308 to manage virtual call tokens associated with a user. In FIG. 3B, a user has selected the option 306 to create a new virtual call token. The user receives a notification indicating that a new virtual call token has been generated. In this example scenario, the virtual call token is a hyperlink. The user is provided with an option 310 to copy the hyperlink. The user can then send the hyperlink to any other users so that the other users can call the user using the hyperlink. For example, the user can send the hyperlink by using email, by using an instant messenger application, or by printing the hyperlink on physical cards and passing out the cards, and the like.

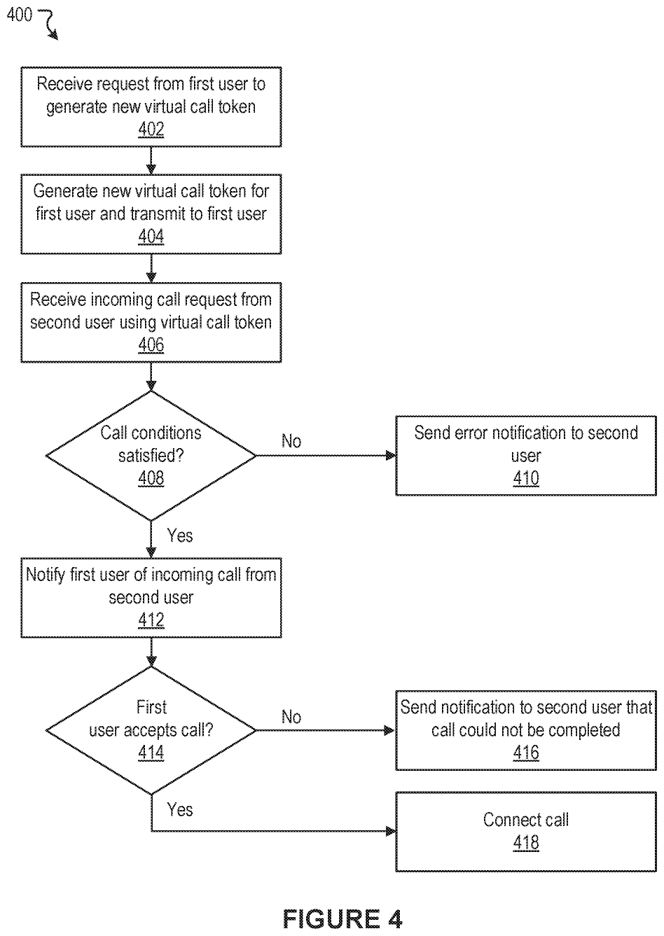

FIG. 4 illustrates an example flow diagram 400 associated with implementing digital communications based on virtual call tokens, according to an embodiment of the presently disclosed technology. The flow diagram 400 may represent steps that are taken, for example, by the virtual call token module 102. At block 402, a request is received from a first user to generate a new virtual call token. At block 404, a new virtual call token is generated for the first user and transmitted to the first user. At block 406, an incoming call request is received from a second user. The incoming call request has been generated using the virtual call token that was generated for the first user. At block 408, a determination is made as to whether one or more call conditions associated with the virtual call token are satisfied. If the one or more call conditions are not satisfied, the flow diagram 400 moves to block 410, where a notification is sent to the second user notifying the second user that the call could not be completed. If the one or more call conditions are satisfied, the flow diagram 400 moves to block 412, where the first user is notified of an incoming call request from the second user. At block 414, a determination is made as to whether or not the first user has accepted the call. If the first user does not accept the call, the flow diagram 400 moves to block 416, where the second user is notified that the call could not be completed. If the first user does accept the call, at block 418 the call between the first user and the second user is connected.

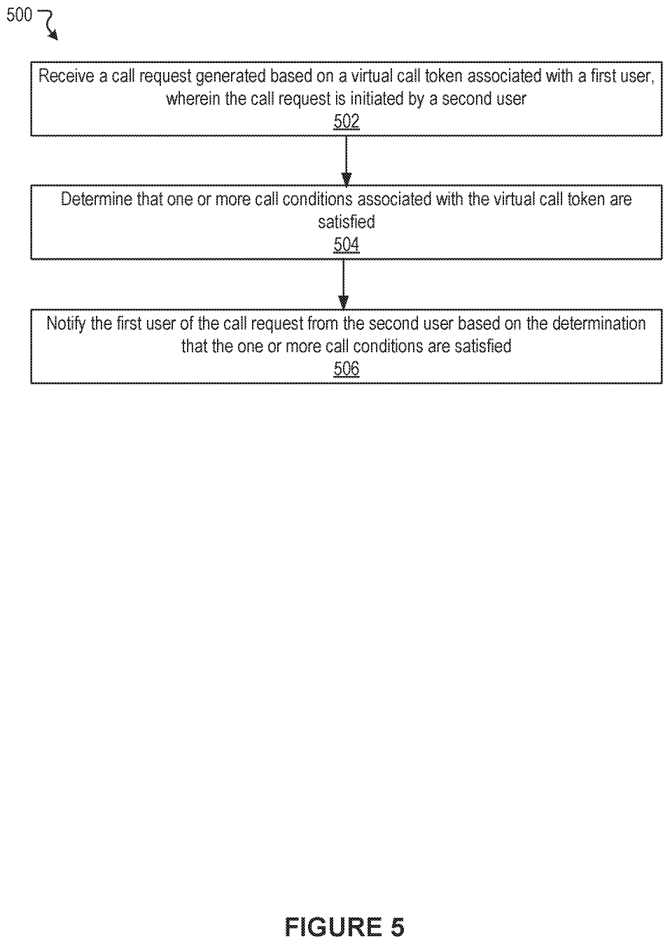

FIG. 5 illustrates an example method 500 associated with implementing digital communications based on virtual call tokens, according to an embodiment of the presently disclosed technology. It should be appreciated that there can be additional, fewer, or alternative steps performed in similar or alternative orders, or in parallel, within the scope of the various embodiments discussed herein unless otherwise stated.

At block 502, the example method 500 can receive a call request generated based on a virtual call token associated with a first user, wherein the call request is initiated by a second user. At block 504, the example method 500 can, determine that one or more call conditions associated with the virtual call token are satisfied. At block 506, the example method 500 can notify the first user of the call request from the second user based on the determination that the one or more call conditions are satisfied.

It is contemplated that there can be many other uses, applications, and/or variations associated with the various embodiments of the presently disclosed technology. For example, in some cases, user can choose whether or not to opt-in to utilize the disclosed technology. The disclosed technology can also ensure that various privacy settings and preferences are maintained and can prevent private information from being divulged. In another example, various embodiments of the presently disclosed technology can learn, improve, and/or be refined over time.

### Social Networking System—Example Implementation

FIG. 6 illustrates a network diagram of an example system 600 that can be utilized in various scenarios, according to an embodiment of the presently disclosed technology. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a virtual call token module 646. The virtual call token module 646 can, for example, be implemented as the virtual call token module 102, as discussed in more detail herein. In some embodiments, one or more functionalities of the virtual call token module 646 can be implemented in the user device 610. It should be appreciated that there can be many variations or other possibilities.

### Hardware Implementation

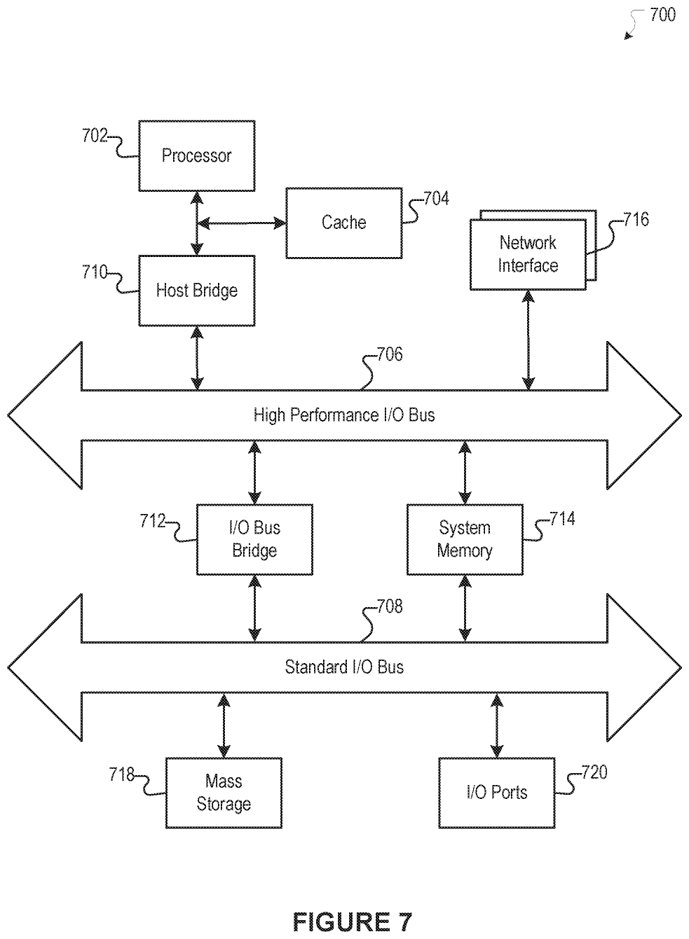

The foregoing processes and features can be implemented by a wide variety of machine and computer system architectures and in a wide variety of network and computing environments. FIG. 7 illustrates an example of a computer system 700 that may be used to implement one or more of the embodiments described herein according to an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 620, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

1. A computer-implemented method comprising:
generating, by a computing system, a virtual call token associated with a first user based on information including a profile of the first user, wherein the virtual call token includes a hyperlink containing a universal resource identifier (URI) associated with a software application for generating a call request and a unique identifier associated with the virtual call token, and wherein the hyperlink is selectable to cause the software application to generate the call request;
providing, by the computing system, the virtual call token to a plurality of second users, wherein the virtual call token is associated with one or more call conditions that include whether the plurality of second users have access to a profile of the first user and whether the plurality of second users are permitted to initiate a call request associated with the first user;
modifying, by the computing system, the one or more call conditions associated with the virtual call token to remove users from the plurality of second users permitted to initiate a call request associated with the first user;
receiving, by the computing system, a call request generated based on the virtual call token associated with the first user, wherein the call request is initiated by a second user of the plurality of second users and the call request includes identifying information associated with the second user, the identifying information including a link to a profile of the second user;
determining, by the computing system, that the one or more call conditions associated with the virtual call token are satisfied, wherein the one or more call conditions include whether the second user of the plurality of second user is permitted to use the virtual call token; and
notifying, by the computing system, the first user of the call request initiated by the second user of the plurality of second users based on the determining that the one or more call conditions are satisfied, wherein the notifying the first user of the call request initiated by the second user of the plurality of second users comprises providing identifying information of the second user including a profile picture of the second user of the plurality of second users from the profile of the second user of the plurality of second users.

2. The computer-implemented method of claim 1, wherein the virtual call token further includes at least one of a QR code or an alpha-numeric sequence.

3. The computer-implemented method of claim 1, wherein the call request is generated based on the second user of the plurality of second users selecting the hyperlink.

4. The computer-implemented method of claim 3, wherein the hyperlink is a deep link, and further wherein selection of the hyperlink causes a computing device to automatically open a messaging application to generate a call request.

5. The computer-implemented method of claim 1, wherein the call request comprises user identifying information associated with the second user and the unique identifier associated with the virtual call token.

6. The computer-implemented method of claim 1, wherein the one or more call conditions comprise a time-based condition.

7. The computer-implemented method of claim 6, wherein the time-base condition specifies at least one of a first time range during which the virtual call token is operative, or a second time range during which the virtual call token is inoperative.

8. The computer-implemented method of claim 1, wherein the notifying further comprises providing a notification on multiple instances of a messaging application associated with the first user.

9. The computer-implemented method of claim 1, wherein the virtual call token is provided to a third user who is not permitted to use the virtual call token and the third user is provided, in response to an attempt to initiate a call request based on the virtual call token, with a message indicating that the third user is not authorized to use the virtual call token.

10. The computer-implemented method of claim 1, wherein
the first user is associated with a plurality of virtual call tokens,
a first virtual call token of the plurality of virtual call tokens is associated with a first set of call conditions, and
a second virtual call token of the plurality of virtual call tokens is associated with a second set of call conditions that is different from the first set of call conditions.

11. A system comprising:
at least one processor; and
a memory storing instructions that, when executed by the at least one processor, cause the system to perform a method comprising:
generating a virtual call token associated with a first user based on information including a profile of the first user, wherein the virtual call token includes a hyperlink containing a universal resource identifier (URI) associated with a software application for generating a call request and a unique identifier associated with the virtual call token, and wherein the hyperlink is selectable to cause the software application to generate the call request;
providing the virtual call token to a plurality of second users, wherein the virtual call token is associated with one or more call conditions that include whether the plurality of second users have access to a profile of the first user and whether the plurality of second users are permitted to initiate a call request associated with the first user;
modifying the one or more call conditions associated with the virtual call token to remove users from the plurality of second users permitted to initiate a call request associated with the first user;
receiving a call request generated based on the virtual call token associated with the first user, wherein the call request is initiated by a second user of the plurality of second users and the call request includes identifying information associated with the second user, the identifying information including a link to a profile of the second user;
determining that the one or more call conditions associated with the virtual call token are satisfied, wherein the one or more call conditions include whether the second user of the plurality of second user is permitted to use the virtual call token; and
notifying the first user of the call request initiated by the second user of the plurality of second users based on the determining that the one or more call conditions are satisfied, wherein the notifying the first user of the call request initiated by the second user of the plurality of second users comprises providing identifying information of the second user of the plurality of second users including a profile picture of the second user of the plurality of second users from the profile of the second user of the plurality of second users.

12. The system of claim 11, wherein the virtual call token further includes at least one of a QR code or an alpha-numeric sequence.

13. The system of claim 11, wherein the call request is generated based on the second user of the plurality of second users selecting the hyperlink.

14. The system of claim 13, wherein the hyperlink is a deep link, and further wherein selection of the hyperlink causes a computing device to automatically open a messaging application to generate a call request.

15. The system of claim 11, wherein the call request comprises user identifying information associated with the second user and the unique identifier associated with the virtual call token.

16. A non-transitory computer-readable storage medium including instructions that, when executed by at least one processor of a computing system, cause the computing system to perform a method comprising:
generating a virtual call token associated with a first user based on information including a profile of the first user, wherein the virtual call token includes a hyperlink containing a universal resource identifier (URI) associated with a software application for generating a call request and a unique identifier associated with the virtual call token, and wherein the hyperlink is selectable to cause the software application to generate the call request;
providing the virtual call token to a plurality of second users, wherein the virtual call token is associated with one or more call conditions that include whether the plurality of second users have access to a profile of the first user and whether the plurality of second users are permitted to initiate a call request associated with the first user;
modifying the one or more call conditions associated with the virtual call token to remove users from the plurality of second users permitted to initiate a call request associated with the first user;
receiving a call request generated based on the virtual call token associated with the first user, wherein the call request is initiated by a second user of the plurality of second users and the call request includes identifying information associated with the second user, the identifying information including a link to a profile of the second user;
determining that the one or more call conditions associated with the virtual call token are satisfied, wherein the one or more call conditions include whether the second user of the plurality of second user is permitted to use the virtual call token; and
notifying the first user of the call request initiated by the second user of the plurality of second users based on the determining that the one or more call conditions are satisfied, wherein the notifying the first user of the call request initiated by the second user of the plurality of second users comprises providing identifying information of the second user of the plurality of second users including a profile picture of the second user from the profile of the second user of the plurality of second users.

17. The non-transitory computer-readable storage medium of claim 16, wherein the virtual call token further includes at least one of a QR code or an alpha-numeric sequence.

18. The non-transitory computer-readable storage medium of claim 16, wherein the call request is generated based on the second user of the plurality of second users selecting the hyperlink.

19. The non-transitory computer-readable storage medium of claim 18, wherein the hyperlink is a deep link, and further wherein selection of the hyperlink causes a computing device to automatically open a messaging application to generate a call request.

20. The non-transitory computer-readable storage medium of claim 16, wherein the call request comprises user identifying information associated with the second user and the unique identifier associated with the virtual call token.
